(19) United States
(12) Patent Application Publication
(10) Pub. No.: US 2017/0104707 A1
(43) Pub. Date: Apr. 13, 2017

(54) Multimedia Communication Platform

(71) Applicant: Pascal Bonifay, New York, NY (US)

(72) Inventor: Pascal Bonifay, New York, NY (US)

(21) Appl. No.: 15/289,763

(22) Filed: Oct. 10, 2016

Related U.S. Application Data
(60) Provisional application No. 62/239,083, filed on Oct. 8, 2015.

(51) Int. Cl. H04L 12/58; G06K 7/14; G06K 19/06

(52) U.S. Cl. CPC H04L 51/18; H04L 51/10; H04L 51/20; G06K 19/06037; G06K 7/1417

(57) ABSTRACT

A system and method for sharing a digital message with a user over a network, including a tag associated with the digital message, and a user device capable of communicating over the network, the user device including a tag reader for detecting, reading and decoding information relating to the tag, a memory for storing information relating to the user, and a software application for transmitting the information relating to the tag and the information relating to the user and for receiving the digital message based on the information relating to the tag and the information relating to the user over the network, wherein the user device displays the digital message.

### FIELD OF THE INVENTION

The present invention relates to a system and method for sharing multimedia messages using a unique physical scannable item by a user device.

### BACKGROUND OF THE INVENTION

Sharing messages and media using electronic user devices is an integral part of communication. Individuals connect with friends and advertisers alike via such messages. At the present time, most of these messages are dependent on “adding” or “following” a user, where all “followers” receive the same message. Further, most electronic messages today can be accessed or opened by a user at any time or location.

The present invention however allows a sender to customize a message based on who receives it, as well as a number of other factors. Thus, users can target specific individuals or groups to receive a certain message, based on a combination of criteria (such as gender, age, location, time, weather, etc.), while allowing others to receive a different, separate message. The present invention may associate certain messages with a physical item or location, ensuring that a user receives the message at an ideal time, either when the user is near a specific object or at a specific location for which the message is particularly relevant.

### SUMMARY OF THE INVENTION

In general, in one aspect, exemplary embodiments of the present invention may provide a system for sharing a digital message with a user over a network, including a tag associated with the digital message, and a user device capable of communicating over the network, the user device including a tag reader for detecting, reading and decoding information relating to the tag, a memory for storing information relating to the user, and a software application for transmitting the information relating to the tag and the information relating to the user and for receiving the digital message based on the information relating to the tag and the information relating to the user over the network, wherein the user device displays the digital message.

Implementations of various exemplary embodiments of the present invention may include one or more of the following features. The user device further includes a geo-location device for obtaining information about the location or orientation of the user device, the software application further transmitting the information about the location or orientation of the user device and receiving the digital message based on the information about the location or orientation of the user device. The software application further includes a chat function associated with the tag by which the user responds to the message. The information relating to the user includes one or more of the user's location, age, preferred language, and gender. The tag is associated with a physical object. The digital message is audio or video. The tag is printed in connection with an article and provides additional information about the subject of the article.

In general, in one aspect, exemplary embodiments of the present invention may provide a system for sharing a digital message with a user device of a user over a network, including a tag associated with the digital message, and a server capable of communicating with the user device over the network, the server including a database for storing an identification of the tag and the digital message, a memory for storing information relating to the user, and a processor for receiving information relating to the tag and the information relating to the user and for transmitting the digital message to the user device based on the identification of the tag and the information relating to the user, such that the user device displays the digital message.

Implementations of various exemplary embodiments of the present invention may include one or more of the following features. The processor further transmits the digital message to the user device based on information about the location or orientation of the user device received from the user device. The information relating to the user includes one or more of the user's location, age, preferred language, and gender. The tag is associated with a physical object. The digital message is audio or video. The tag is printed in connection with an article and provides additional information about the subject of the article.

In general, in one aspect, exemplary embodiments of the present invention may provide a method for sharing a digital message with a user device of a user over a network, including reading a tag associated with the digital message to detect and decode information relating to the tag, transmitting the information relating to the tag and information relating to the user over the network to a remote server, transmitting the digital message to the user device based on the information relating to the tag and the information relating to the user over the network, and displaying the digital message on the user device.

Implementations of various exemplary embodiments of the present invention may include one or more of the following features. The method may include transmitting information relating to the location or orientation of the user device to the remote service; and transmitting the digital message to the user device based on the information relating to the location or orientation of the user device. The method may include exchanging further messages between the server and the user device over the network. The information relating to the user includes one or more of the user's location, age, preferred language, and gender. The digital message is audio or video. The tag is associated with an article and provides additional information about the subject of the article.

### BRIEF DESCRIPTION OF THE DRAWINGS

FIG. 1 illustrates the interaction of the system of the present invention with an application on a user device;

FIG. 2 illustrates the process of creating and receiving user-specific Tags in accordance with the present invention;

FIG. 3a illustrates the process of creating Tags that are connected to a location and that are user specific;

FIG. 3b illustrates the process of receiving Tag content that is connected to a location and orientation and that are user specific;

FIG. 4 illustrates the chat function of the system of the present invention;

FIG. 5 shows an overview of the multimedia platform system of the present invention;

FIG. 6 illustrates the user device and its features;

FIG. 7a illustrates the interaction of the system of the present invention with an application on a user device;

FIG. 7b illustrates a continuation of the interaction of the system of the present invention with an application on a user device shown in FIG. 7a; and

FIG. 7c illustrates a continuation of the interaction of the system of the present invention with an application on a user device shown in FIGS. 7a and 7b.

### DETAILED DESCRIPTION OF THE INVENTION

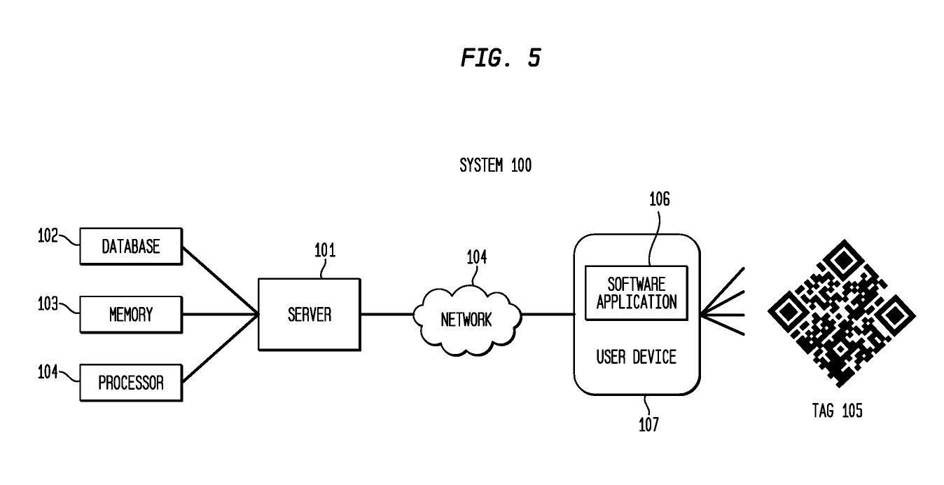

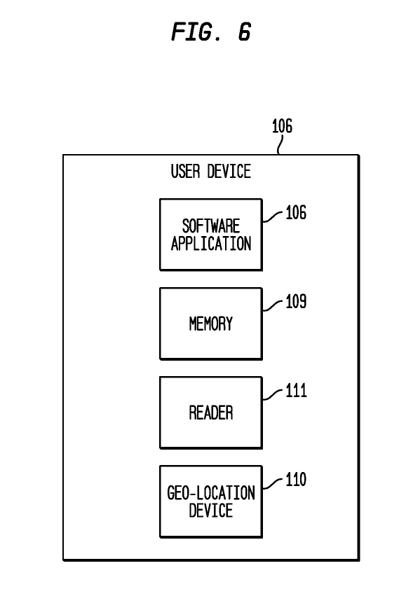

The present invention relates to a multi-track multimedia platform or system 100 that plays a message or a list of messages for specific individuals or groups via a pre-identified item referred to herein as a Tag 105. The Tag is preferably a unique physical indicator such as a QR code although advanced embodiments may use an image of an object, such as a work of art, as the indicatory. The system 100, as illustrated in FIG. 5, includes a server 101 having a database 102, memory 103, and processor 112 connected to a network 104, at least one unique pre-identified Tag 105, and a user device 107 connected to the network 104. The user device 107 includes a software application 106 installed thereon, a reader 111 capable of detecting, reading and decoding Tag 105, a memory 109, and a geo-location device 110, as seen in FIG. 6. The Tag 105 is recognized by a reader device using the software installed on a user device.

The Tag 105 preferably includes a QR code rotated by 135°, although any angle of rotation is possible. The rotation, at any degree measure, may difficult for other readers to decipher, since they are intended to read upright codes. This features makes the present invention distinct from other code-based systems and encourages users to use the system of the present invention over other readers. Alternatively, the Tag 105 may include any code, barcode, image, item, landscape, RFID or NFS tags, etc., that are recognizable by the reader and usable by the software. The Tag 105 may be printed and affixed to an object or printed in a publication. For example, the Tag 105 may be printed on postcards, on gift cards, in a booklet included in the package of an item, or on an item itself, such as a cup, mug, item of jewelry, label, etc.

Each Tag 105 is a unique pattern or identifier and is registered in the server's database. The database associates a specific Tag with a URL, i.e., an internet address. The Tags are therefore able to be connected to unique data, specifically a unique URL that may be associated with a message, video, audio, or other information. The message may be continually changed. Since the content associated with a Tag 105 is updatable at any time, a user could scan the same Tag every day and receive an update about the subject of the Tag. To use the system and access the associated URL and message, a user scans the Tag 105 with a smartphone having a reader, which may include a camera, or other electronic user device 107 including the software application 106. Other user devices may include tablets, smartwatches, or handheld computers. Each user device contains data about the user of the device, such as, for example, the location of the user device, the age and gender of the user, the user's email address or phone number, the user's preferred language, or affiliations of the user. This information may be obtained through the user's settings on the device or through built in functions on the device.

Once a Tag 105 is scanned by a user, the software application on the user device will receive information obtained by the reader from the Tag. If the Tag information contains a fully qualified URL that points to the server, the URL will be used as is, but if the Tag information only contains an identifier (e.g., a barcode), the software application will build a URL to contact the server, including this identifier. The software application will then send a network request using this URL, adding specific information, such as geo-localization, preferred language and the user's identifier. Once this request is received, the server uses the information to find all the content relative to the given Tag in the database, find user specific information stored in the database, and select the most relevant content based on any contextual information provided or available (user's information, geo-location of user's device, user's scan history, user's location's weather, time and date, etc.). The server then returns a precise description of the matching content. The description is included in the request response body sent by the server, after the software application has sent the request to the server. Each description contains all the information regarding how to display the content and where to locate the related resources including, but not limited to, images, sounds, text or videos. Once the software application has received the response and description from the server, it displays the corresponding multimedia content as described and/or loads the corresponding media.

Each content descriptor may contain information relative to, for example, kind (simple, carousel, ribbon, etc.), size (expressed in percentage of its host track or if it is a root content expressed in percentage of the screen), layout (background color, background image, position and sizing, borders color, type), shape (round, star, oval, etc.), text (a rich text HTML format describing alignment, fonts, sizes, colors, etc of the text), audio (file or stream URL), audio player's skin to display when the sound is playing, audio player's text (a simple text to display in the audio player, such as the audio track name, for example), audio player features (stream (no user actions possible), simple (only play pause button), full (play, pause, next, previous and navigable timebar), autoplay (defining if sound should play automatically when loading), sound delay (to perform advanced synchronization in the streaming context), video (to embed in the application), a list of a user's interactions (events and actions to describe how the user can interact with the content; possible events being to tap, double tap, press, swipe left, swipe right, swipe up, swipe down; possible actions being email to, navigate to, link to other tag, animate, pause animation), animation (type being pulse, rotate, shake etc., when being once, repeat or on event, duration being the time to complete the animation), list of tracks, and list of nested content within tracks (i.e., a track content can embed other “sub-track” content, displayed within the grid of the current track with the same possible properties).

In situations where the content is a video stream (a video flux which cannot be interrupted, such as, for example, live television), the server will compare the delay (latency) between the user's reception and the source. The server will then add an accurate delay request in the description to play the audio synched with the video.

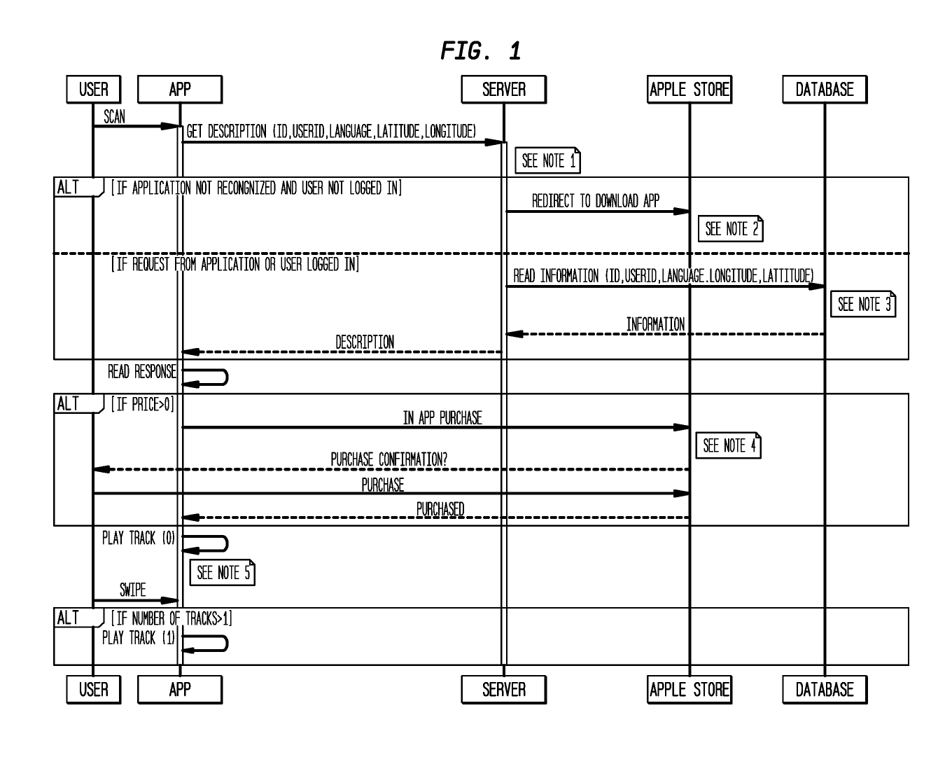

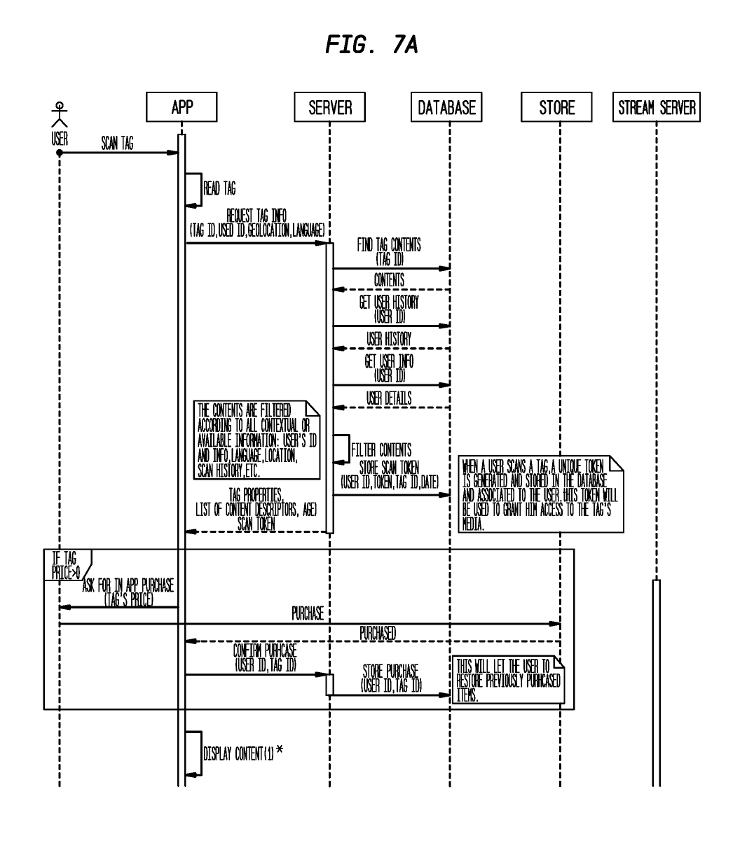

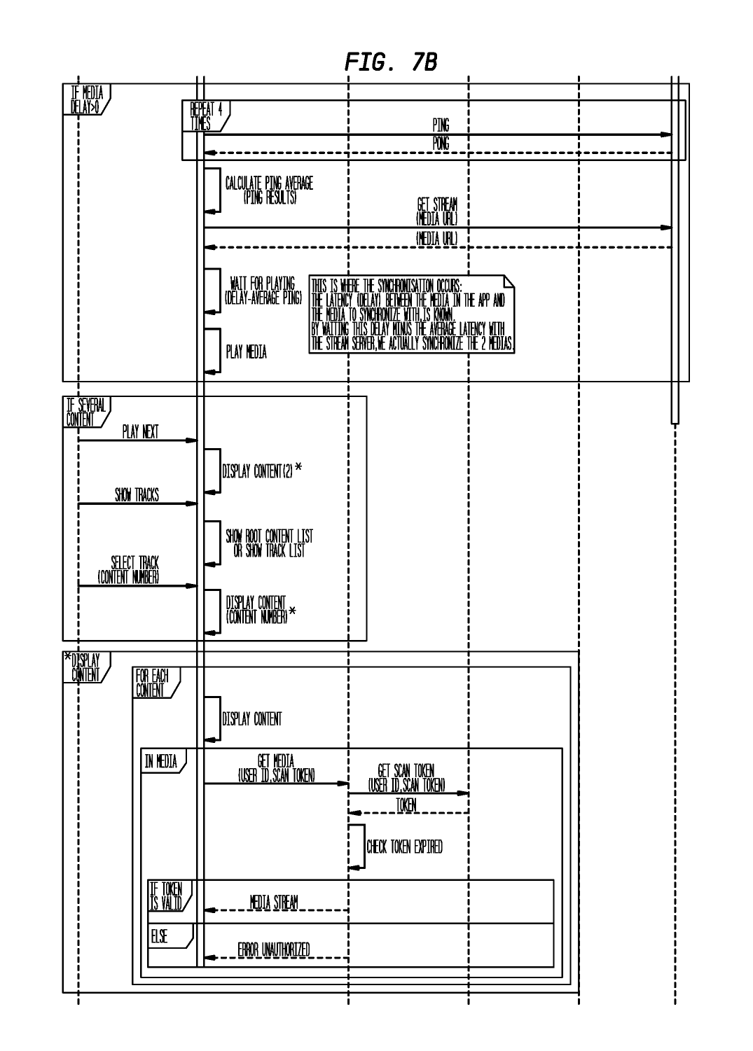

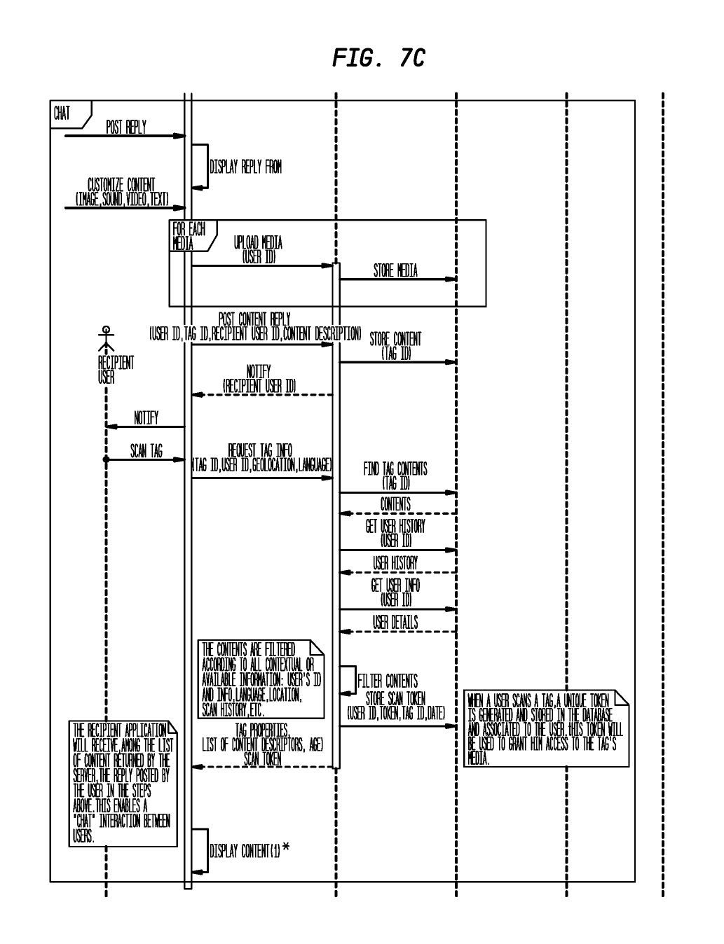

In a preferred embodiment, if a user scans a valid Tag 105 from a scanner application that is not associated with the system of the present invention, the server 101 may redirect the request to the device's Application Store (Apple App store or Google Play store for Android based systems) to download the software application 106 onto the user's device. This embodiment is illustrated in FIG. 1, FIG. 7a and FIG. 7b. FIG. 7b is a continuation of the interactions shown in FIG. 7a.

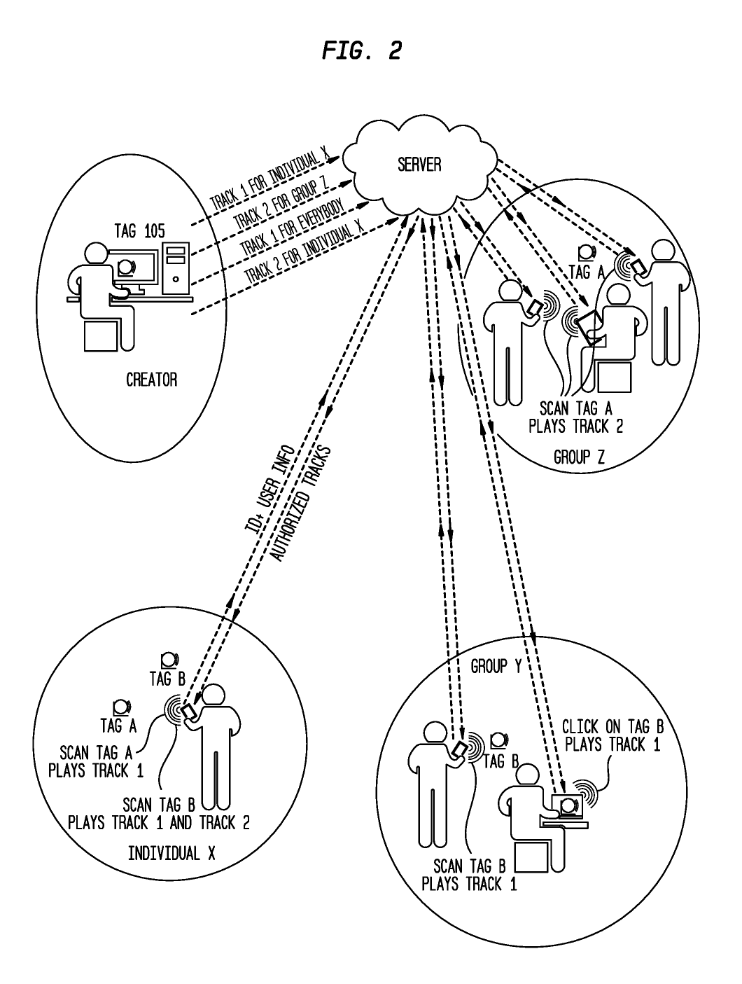

In some embodiments of the present invention, a user can create Tags 105. Creators and users may be individuals, groups, or brands. Tags 105 can be created through the software application 106 either by associating a multimedia message with an existing scannable item 105 or by creating a new scannable item 105 to associate the Tag with a message. The creator of the Tag 105 can authorize or prevent the access to any digital message associated with the Tag 105 to any individual or group based on various parameters, such as, for example, geo-localization, age of the user, date, time, the number of times an individual or group scanned one specific scannable item 105, or any other discriminating factor. The creator can also make messages user specific. For example, the creator of the Tag A can allow the Individual X, preferably identified by an ID number, to access two multimedia messages labeled as Track 1 and Track 2 upon scanning Tag A. The creator of the Tag A can also restrict a user's access to Track 1 so that another user scanning Tag A will only have access to Track 2. Similarly, a creator may create Tag B, which provides Individual X access only to Track 1 and Group Z access only to Track 2. This embodiment is illustrated in FIG. 2. Such customization is possible because, as discussed, the system 100 gathers and sends information about the user to the server along with the Tag information. The server 101 then sends the application metadata and message descriptions including instructions that the application follows to automatically play messages.

For example, the system 100 may instruct the software application 106 to open a message only at a specific location. The location need not be the same location as the location where the Tag 105 is scanned. Instead, a user may scan a Tag 105, causing the message to be downloaded to the user device, where it will be stored until the user and user device reach the designated location. Once the user and user device reach the location, the message will automatically play on the user device. In this embodiment, when the Tag creator creates or records his or her multimedia messages, he or she also sends precise geographic coordinates and/or orientation to the server. When the server 101 detects a user scanning a Tag 105 with a reader device containing software 106, all the tracks attached to this Tag 105 that this user is authorized to have access to will be sent to the user's device 107, with instructions for the device to play certain tracks based on the localization and the orientation of the device. The first Track may play automatically. Then, when the user and his device move, the location of the user's device will change. When the location and orientation of the device match a second recorded Track's registered coordinates and orientation, the second Track containing a second multimedia message may automatically play.

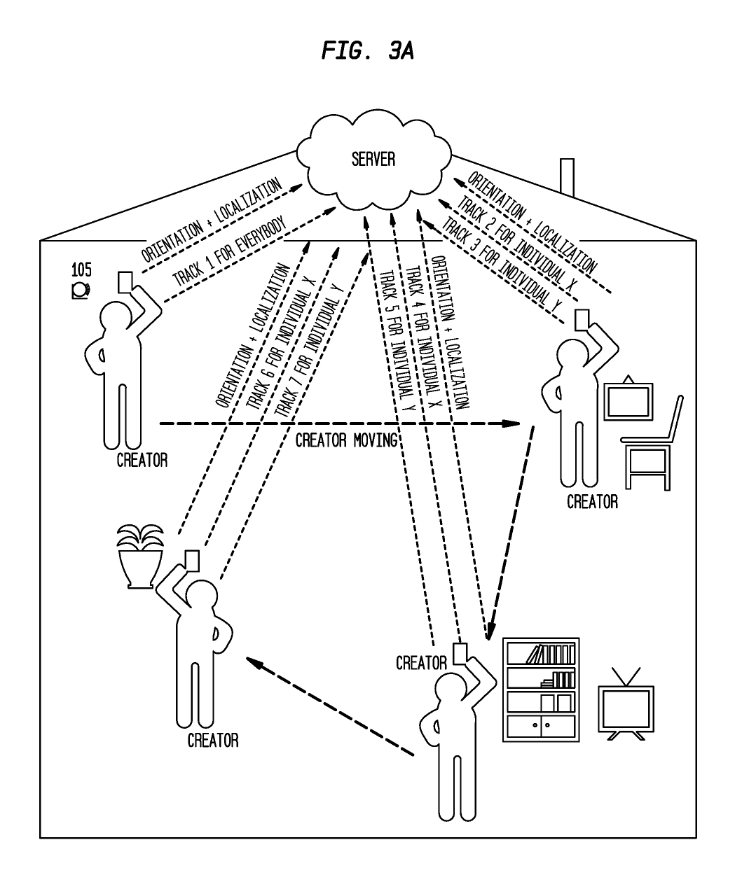

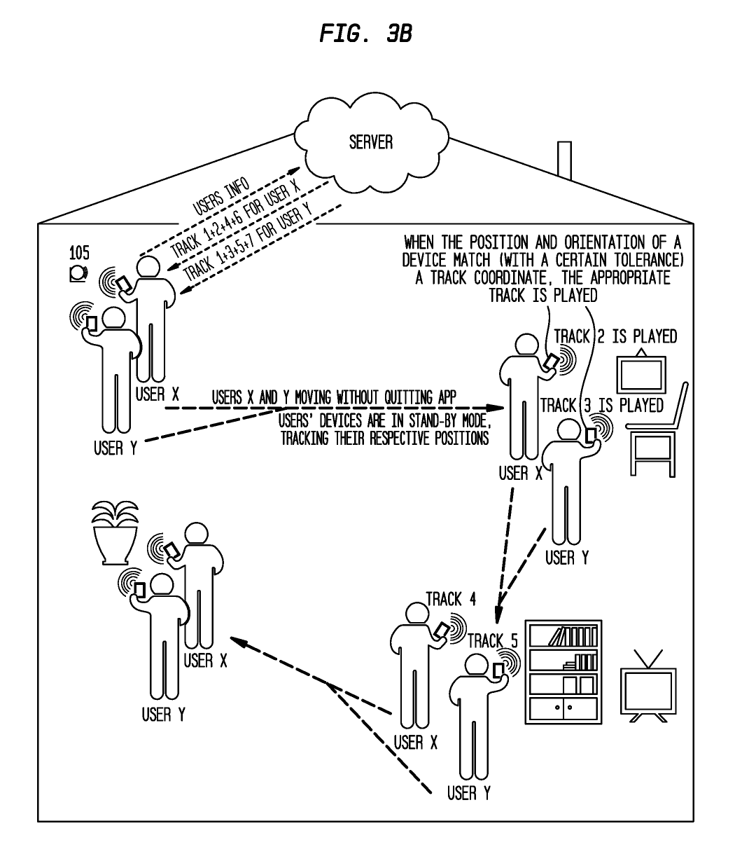

FIGS. 3a and 3b illustrate an embodiment of the present invention. First, a creator can create a series of messages that are displayed when a user reaches different locations. The creator may record a first message associated with the Tag 105 and then additional messages associated with different geo-locations and device orientations. With each message, the creator may also indicate which users may access the message. This process is illustrated in FIG. 3a. In this example, the user creates two different messages, one addressed to the User X and one addressed to the User Y, along with a general greeting message for all users. The messages may be associated with three different locations, e.g., in the creator's house. To create the messages, the creator records messages, e.g, at the armchair, the television, and the plant, each time orienting his user device, e.g. a smartphone, to the same orientation that User X and User Y will orient their devices when scanning a Tag at each location.

To receive the messages available on the system's server by a location option, the user first scans a pre-identified item or Tag 105. In the preferred embodiment shown in FIGS. 3a and 3b, this action prompts the user device to automatically deliver the general greeting message, e.g. Track 1. Users are then able to move from one location to another and have new personalized messages displayed at specific locations automatically. This embodiment is shown in FIG. 3b. User X and User Y first scan the Tag, and then their devices play the same greeting message, e.g. Track 1. If they both move to the armchair without quitting the software application, when each user points his or her device in the direction of the armchair, a message will automatically play for User X, while another message will automatically play for User Y. The same will occur when User X and User Y are close to the television and orient their phones in its direction. Again, the same will occur when User X and User Y are near the plant.

The Tag 105 does not need to be associated with a location. Due to the Tag's unique identifier, i.e. QR or bar code pattern, RFID, etc., the Tag may have a number of associations, such as, for example, a specific object, a work of art, etc. In this case, the Tag may provide a message with general information about the work or a personalized message to the owner. The Tag may alternatively be associated with a specific song or album and send fans who have scanned the Tag updates from the artist or a link to concert schedules. The Tag might also have no specific generally association and instead have individual person associations so that it delivers the same or a different message to each user who scans it.

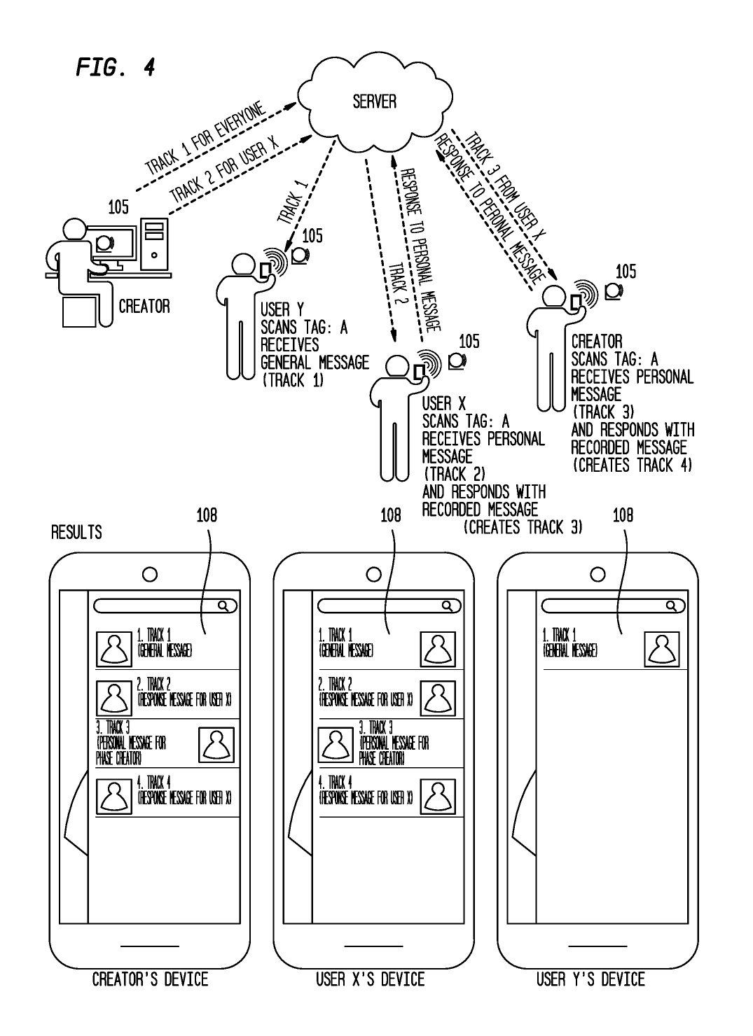

The system also includes a response platform referred to herein as a chat function, as illustrated in FIG. 4. This function allows users to post a response to a particular Tag 105 to create a chat experience. The Tag creator may enable or disable this feature, or authorize or exclude certain users or groups. After an authorized user has scanned the Tag 105, a message that the Tag creator has authorized the chat function is automatically displayed on the user's device. In the preferred embodiment, while and after the message is played, the user is invited to tap on the chat icon, bringing up a menu on the user device. The user is then invited to upload or record audio, text, image, video, or a combination of these. The user is able to choose to restrict access to the response to the Tag creator only, or to allow other users to see the response as well. When the response message is created, the server adjusts the track list 108 of the Tag 105 associated with the response message to include a new Track containing the response message, taking into account the restrictions if necessary to show each user a user-specific track list.

A creator may customize track list settings as well. In one embodiment, a user can have access to the track list of each Tag 105 from the software application 106 by swiping left on the device's screen. At any time, any user is able to visualize this track list in chronological order, as sorted by keywords, or in a personal order as prearranged by the user.

A Tag creator may also authorize access to a message without scanning a Tag. In this case, the chat is stored in the storage section of the software application. In this manner, the tracks are directly accessible in the application, and responses may continually be added. The storage section may also include purchasable content, such as music, streaming content, and a history of Tags that have been already played, among other features.

In another example embodiment, as illustrated in FIG. 4, the creator attaches a general message, e.g. Track 1 to a Tag A, along with a personal message, e.g. Track 2, for User X only. The creator also enables the chat function for User X only. When User X scans Tag A, two Tracks are available to User X, the General Message and the Personal Message. User X also has the option, preferably in a menu list, to upload his or her own message as a response message. When User Y scans the Tag A, the general message, Track 1, plays automatically. There is no option for User Y to upload a new response track attached to the Tag A because the chat function is disabled for that user. Track 1 is the only message available in the Tag A track list 108 for User Y.

If User X decides to upload a response message addressed to the creator only, User X will upload a message via the software application. The Tracks 1, 2, and 3 are now available in Tag A's track list 108 for User X and the creator, but User Y is still only able to see Tracks 1 and 2. The new response message may play on the creator's user device automatically or only upon the creator's scanning the Tag A. The creator can also upload a response message, either in response to Tracks 1, 2, or 3, as authorized by the creator's chat function settings. If the creator uploads a response, this response message will be listed as Track 4 on the track list 108 of Tag A for User X and the creator.

The system of the present invention can be used in many different industries to share a wide variety of data. In another embodiment of the invention, one unique Tag is printed on all of the tickets of a sports game. The Tag may be associated with a streaming live radio broadcast. A ticket holder may then scan the Tag to listen to live comments during the game. Further, the ticket holders may see, preferably by swiping left using the system's software application, several tracks or messages that can be purchased. For example, one track may offer audio comments on other games played at the same time in other cities. The team may also offer promotions such as giving free access to live commentary for fans who have purchased more than ten tickets in the last year, or allowing fans younger than fifteen years old to hear a song from the Billboard top fifty during each time out. A geo-restriction can apply to this Tag as well. For example, if a fan keeps his or her ticket and tries to scan the Tag outside of the stadium, he or she will not be able to connect to the streamed radio. Instead, the fan may receive an error message or a general message informing him or her about the game calendar for the current month, for example.

In another embodiment of the present invention, the system is used as a “white label” by a printer company. The company will have integrated the system in its driver software so that any user of its software can access the system by clicking on a logo or box. If this option is selected, a Tag will be created automatically in the system's server. The Tag is then printed. In one embodiment, the Tag includes an audio version of the printed text as read by a speech synthesizer. When a third party receives the print Tag, he or she is able to scan the Tag with a user device and hear the message read aloud. The message can be played according to the characteristics of the third party as well. For example, the message may be in the user's preferred language or, for example, if the third party is older than 70, the text may be displayed on his or her device screen in a large font.

This format can also be used for books, dictionaries, pamphlets, posters, postcards, gifting cards, magazines, or any printable item in general. For example, by printing a Tag on a page in a magazine or book, a user may be able to scan the Tag and hear an audio version of the text printed on that page in his own language. Each page can be stored as a track, and a simple swipe left in the software application shows a track list of all the audio versions of the pages.

A Tag can also be used to provide additional information. For example, a Tag associated with a magazine article may contain sounds, videos, or background related to the article. In another embodiment, the Tag may offer specific groups, identified by personal data, exclusive content such as a new song by an artist discussed in the article. The chat option can be unlocked and the reader of the article may be able to post a message addressed to the magazine. The publisher may have the option to make these posts public or not.

A Tag may also be included in a printed advertisement. The Tag may then, for example, send a user an advertisement directed to his or her specific age and location.

In another example, a Tag printed on a concert poster may give a user the opportunity to hear a song from the band for free. In another example, the Tag will only give the user the opportunity to hear a song from the band if the user is located in a city where the band will be playing. In a further example, the user will be able to swipe left to see other songs from the band, and be able to purchase these songs. If the user is recognized as a fan, the user may receive a personal message recorded by the leader of the band.

In another embodiment, one unique Tag is printed on all the cereal boxes of a given brand. For example, Matt, 10 years old, decides to scan the Tag with his smartphone Monday morning while eating the cereal. A story associated with the Tag and Matt's specifics starts to play in the software application on Matt's phone automatically. The story describes a charming prince named Matt who is taking his horse to go to a castle to save a princess. Tuesday morning, Matt decides to scan the same Tag, but now, in the same story Prince Matt is approaching the castle and has to fight a Dragon. The same day, Matt's sister, Emily, 8 years old, also decides to scan the same Tag, but with her own user device. A different story starts on the software application on her device. This story is about a beautiful princess named Emily who has to deal with a very strict father. Right after Emily has finished eating the cereal, Matt scans the Tag again, but this time no story plays. Instead he is invited to scan the Tag again tomorrow to hear the rest of the story. If Matt swipes left on his device, he will be able to see the Tracks he already heard yesterday and today. He taps on track one to listen to the beginning of the story again. If Matt's and Emily's father scans the Tag with his own device, he sees a weather forecast of the next three days in his city. Thus, the system is able to adjust the message based on information about the user.

In another embodiment, a car service company, such as Uber® or Lyft®, puts a sticker displaying a unique Tag in the back seat of each of its cars. A user, Max, is sitting in one of the cars and decides to scan the Tag using his smartphone. Upon scanning the Tag, the system identifies the user as Max and a video message recorded for him by his girlfriend, Jane, plays automatically on his device. She reminds him to bring a bottle of wine with him to the party that he is on his way to now. Jane is on her to way to the same party but in a different car. Jane has decided to use the system rather than a text message or email to ensure that Max gets the message when he is in a car on the way to the party, rather than before he leaves when he is likely to forget the message. By attaching the Tag to an object, in this case a car or taxi, the sender is able to control where, how and when a message is received. Max is then invited to post a message attached to this Tag via the chat function. He decides to record an audio message for his friend, Tim, saying that he saw Jane's message and that she is in a car with Kate, Tim's best friend who was not supposed to come to this party. A notification appears in Tim's software application telling him that a message is waiting for him in any Uber® car. He will have to scan the Tag for the message to play automatically.

In another embodiment, a Tag is printed on the wristband of every patient in a hospital. In one example, around 10:00 a.m., a cardiologist is visiting his patients in such a hospital. He enters Room 101 and starts to speak with a patient, Andre, who seems to feel better today. An assistant of the doctor who has already scanned Andre's Tag is filming this conversation with a smartphone. The assistant will post the entire interaction between the doctor and Andre as a new track associated with Andre's Tag. The doctor decides to scan Andre's Tag too. The system recognizes that it is the doctor who has scanned the Tag and plays a message from Andre's wife. She says she is worried because Andre has been sleeping a lot and he seemed very tired. The doctor looks at his assistant's device, which is still recording the scene and answers Andre's wife, saying everything she experienced yesterday is normal and expected for the next three or four days. It is 6:00 p.m. now and Andre's wife visits her husband at the hospital again. He is sleeping, and she decides to scan Andre's Tag with her device with the software application installed. The system recognizes the user, and she automatically sees the doctor's video reassuring her that her husband's condition is normal. She feels better immediately and responds to the message with an audio message thanking the doctor for his message. A half hour after she leaves, another visitor comes into Andre's room. This visitor scans Andre's Tag, but he automatically sees a general message inviting him to register as a family member to have access to the private information concerning this patient. This visitor looks again at Andre and realizes he is not in the right room. The confidential information about Andre has not been released, even while Andre is sleeping. The same Tag may be used to send messages between Andre's doctors or other caregivers as well.

In another embodiment, stickers with Tags are put on every street sign in New York City, giving tourists information about the city. For example, a Tag is placed on the four signs near Collect Pond Park where English text gives information about the history of the site. Jorge and his family are visiting New York. He downloads the software application on his and his son's user devices, and purchases a New York Audio Tour on the software application while he is at home in Brazil. The content is pre-downloaded in their devices, but the only way for them to access it is to actually scan one of the Tags in New York City.

When Jorge and his son arrive at Collect Pond Park, Jorge scans a nearby Tag and an audio message about the park automatically plays in Portuguese on his device. At the same time, a map showing the closest Tag on the tour displays on his device's screen. When his son, Manuel, scans the same Tag using his own device, a different message geared towards children plays on his device.

Josh, a native New Yorker is passing by at the same moment. He takes a second to scan the same Tag. As a New York subscriber, his message is completely different. He automatically receives a short “local information” audio message about traffic, trains, weather, etc., for example. He passes by this Tag every morning, and he scans the Tag every day. This embodiment illustrates that one Tag can give multiple user specific messages.

In yet another embodiment, as a promotional event, a headphone company offers a bench in a downtown location with two microphones installed at its opposite ends. The sound captured by these microphones is cancelled by inverting the phase, and the noise cancelling effect is posted on a live stream, to give listeners a moment of quiet. A sticker displaying a Tag in a specific color, the color indicating a brand or other association, is on the bench to let the public know where the promotion takes place. Marc, who walks by with his headphones on, scans this Tag with his smartphone. Automatically, the live stream of the inverted sounds around him plays on his smartphone and headphones. He continues to listen and plays music using the software application. By swiping right, he has access to the storage function where he can access his personal music library, such as that on Spotify®, Tidal®, or iTunes®, which he has connected to the system. He chooses an album to listen to, and he stays on this bench, protected from the surrounding sounds.

The embodiments and examples above are illustrative, and many variations can be introduced to them without departing from the spirit of the disclosure or from the scope of the appended claims. For example, elements and/or features of the different illustrative and exemplary embodiments herein may be combined with each other and/or substituted with each out within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

What is claimed is:

1. A system for sharing a digital message with a user over a network, comprising:
a tag associated with the digital message; and
a user device capable of communicating over the network, the user device including a tag reader for detecting, reading and decoding information relating to the tag, a memory for storing information relating to the user, and a software application for transmitting the information relating to the tag and the information relating to the user and for receiving the digital message based on the information relating to the tag and the information relating to the user over the network;
wherein the user device displays the digital message.

2. The system of claim 1 wherein the user device further comprises a geo-location device for obtaining information about the location or orientation of the user device,
the software application further transmitting the information about the location or orientation of the user device and receiving the digital message based on the information about the location or orientation of the user device.

3. The system of claim 1 wherein the software application further includes a chat function associated with the tag by which the user responds to the message.

4. The system of claim 1 wherein the information relating to the user includes one or more of the user's location, age, preferred language, and gender.

5. The system of claim 1 wherein the tag is associated with a physical object.

6. The system of claim 1 wherein the digital message is audio or video.

7. The system of claim 1 wherein the tag is printed in connection with an article and provides additional information about the subject of the article.

8. A system for sharing a digital message with a user device of a user over a network, comprising:
a tag associated with the digital message; and
a server capable of communicating with the user device over the network, the server including a database for storing an identification of the tag and the digital message, a memory for storing information relating to the user, and a processor for receiving information relating to the tag and the information relating to the user and for transmitting the digital message to the user device based on the identification of the tag and the information relating to the user, such that the user device displays the digital message.

9. The system of claim 8 wherein the processor further transmits the digital message to the user device based on information about the location or orientation of the user device received from the user device.

10. The system of claim 8 wherein the information relating to the user includes one or more of the user's location, age, preferred language, and gender.

11. The system of claim 8 wherein the tag is associated with a physical object.

12. The system of claim 8 wherein the digital message is audio or video.

13. The system of claim 8 wherein the tag is printed in connection with an article and provides additional information about the subject of the article.

14. A method for sharing a digital message with a user device of a user over a network, comprising:
reading a tag associated with the digital message to detect and decode information relating to the tag;
transmitting the information relating to the tag and information relating to the user over the network to a remote server;
transmitting the digital message to the user device based on the information relating to the tag and the information relating to the user over the network; and
displaying the digital message on the user device.

15. The method of claim 14 further comprising transmitting information relating to the location or orientation of the user device to the remote service; and transmitting the digital message to the user device based on the information relating to the location or orientation of the user device.

16. The method of claim 14 further comprising exchanging further message between the server and the user device over the network.

17. The method of claim 14 wherein the information relating to the user includes one or more of the user's location, age, preferred language, and gender.

18. The method of claim 14 wherein the digital message is audio or video.

19. The method of claim 14 wherein the tag is associated with an article and provides additional information about the subject of the article.
